(19) United States
(12) Patent Application Publication
(10) Pub. No.: US 2005/0120291 A1
(43) Pub. Date: Jun. 2, 2005

(54) Method and system for creating on demand, personalized presentation folders

(76) Inventors: Martin J. Guilfoyle, Fort Scott, KS (US); Michael J. Del Chiaro, Fort Scott, KS (US)

Correspondence Address: WARD KRAFT, INC., P.O. BOX 938, FORT SCOTT, KS, 66701, US

(21) Appl. No.: 10/726,155

(22) Filed: Dec. 2, 2003

(51) Int. Cl. G06F 15/00

(52) U.S. Cl. 715/500.1

(57) ABSTRACT

The present invention relates to a method and system for creating, personalized presentation folders on demand or in response to a specific input or request. More particularly, the present invention is directed toward the preparation of personalized or individualized marketing, advertising and communication pieces that can be bundled as presentation and demonstration folders to more efficiently deliver marketing and informational messages to the intended recipients, such as the attendees of a specific presentation. The system of the present invention enables the production of individual pieces of collateral that can be tailored to meet the individual needs of end users such as presenters and sales professionals.

### CROSS-REFERENCES TO RELATED APPLICATIONS

None.

### FIELD OF THE INVENTION

The present invention relates to a method and system for creating, personalized presentation folders on demand or in response to a specific input or request. More particularly, the present invention is directed toward the preparation of personalized or individualized marketing, advertising and communication pieces that can be bundled as presentation and demonstration folders to more efficiently deliver marketing and informational messages to the intended recipients, such as the attendees of a specific presentation. The system of the present invention enables the production of individual pieces of collateral that can be tailored to meet the individual needs of end users such as presenters and sales professionals.

### BACKGROUND OF THE INVENTION

Stock folders are generally well known today and are provided in a variety of colors and in standard formats. Such stock products are created from a blank of material to which at least one and usually two pockets are provided on the inner face of the blank. The pockets are generally formed from the same sheet or blank and are then folded over onto the blank and sealed to the blank to create the pocket. The typical folder dimensions have a length of about 12 inches and a pair of panels each of which is about 9 inches, thus a standard folder runs roughly 12″ by 18″.

Pockets are prepared integrally with the stock folders and have a dimension usually of about 9 inches long and 4 inches wide.

Such folders are used in a number of applications from academic, such as in an elementary, middle school, high school or collegiate environment to professional education purposes including seminars and technical symposiums. In addition, folders have also been used in the past to hand out information on products and services in the hopes of inducing purchases or sales of such products or services.

These prior art folders are available in a broad spectrum of colors and can even have different finishes such as glossy or a metallic appearance in order to supplement the product of topic offering. In addition, such prior art products may also be provided with textural or tactile features so as to resemble grains in leather or wood, again all in an effort to produce or tailor the communication vehicle to the audience or presenter to garner more attention for the products or services being offered.

Examples of such prior art folders include U.S. Pat. Nos. 3,870,223, 4,109,850, 4,301,962, 4,731,142, 4,989,777 and 5,836,507. Each of these prior art constructions are constructed from a single blank of material. That is, the portion making up the folder and which comprises the pocket are part of the same blank. The portion which becomes the pocket is then folded onto the folder portion to create the pocket portion. Such constructions normally require the manufacturer to purchase expensive and complicated folding equipment in order to process and fold the pocket portion, see for example U.S. Pat. Nos. 5,439,436 and 6,063,226.

One of the difficulties with such stock folder products is that the user of such products must order the folders in large lots, or must select from a generic stock inventory that may only have a predetermined number of colors or finish options. If a presenter or distributor would prefer to have at least limited information printed on the folder, such as the name of the company or presenter or to have certain colors or finishes that represent the company, such as to emphasize the trade dress, then the user is stuck with the unfortunate option of having to order such products in large quantities typically greater than 50 and more often in the hundreds as the set up for the production folders is complex and orders in the hundreds of units is normally required by the manufacturer due to the complexity associated with such set up of equipment. This dilemma has thwarted the growth of the folder industry and prevented the use of this tool from expanding its communication potential to users of the product.

Attempts at personalization or individualization have sometimes been elaborate, such as that illustrated by U.S. Pat. No. 5,882,038 in which a personalized sheet is printed and then inserted so that the personalized information is then visible through die cut windows in the blank. As one might imagine, this limits the amount of personalization that can be provided and also requires that the information be aligned with the windows in the folder assembly so that it is visible. In addition, to the steps of folding the blank and the equipment required to accomplish that task, in order to manufacture such a product one needs to add additional die cutting stations and then is faced with the challenge of inserting the personalized sheet of information in the relatively limited confines of the pockets. In preparing for a meeting, even a small meeting, having to insert 10 sheets into 10 different folders can be time consuming, particularly if one is rushed in trying to get to the meeting.

The foregoing prior art products also suffer from the fact that they are provided only in standard configurations, choices of only one or two products having only one or two pockets. This may require the presenter to over stuff the pockets provided with the folder or alternatively to have to distribute multiple folders in order to achieve the communication that is intended, that is in order to discuss multiple products or services multiple folders need to be provided to the attendees of the meeting. In addition, attendees may also wish to include materials collected at the event such as notes, brochures or other collateral material and are faced with stuffing the material into already tight spaces or simply dropping them internally into the folder which can lead to the materials being lost as they are not secured by a pocket. The ability to add additional pockets or the ability to position pockets in different areas of the folder is simply not an option or if it is it may be an expensive option requiring the manufacturer to purchase additional equipment, rework existing equipment or obtain further tooling in order to produce what may only be a single order.

Another problem faced by users of such stock folders is that they have virtually no personalized or individualized information. For example, in a typical introductory business meeting between two entities, the attendees may include an executive, members of sales and marketing and production personnel. Distributing the exact same information to each attendee may result in the information simply being deposited into the attendee's files, instead of the presenter's intent of delivering a specific message to each participant. In addition, any printing that can occur is limited to the amount of space of the blank not covered by the pocket. That is, when processed, blanks are printed on one side (simplex printed) and when the pocket is folded over the blank any printing would be limited only to the upper portion of the blank, thereby limiting the amount of information that can be received by the recipient.

Publications, patents and patent applications are referred to throughout this disclosure. All references cited herein are hereby incorporated by reference.

What is needed therefore is a product that can be produced in a convenient manner that overcomes the foregoing drawbacks. In addition, what is needed is a product that can be customized and tailored to the individual needs of a customer or presenter and one which enables the customer or presenter to convey personalized or individualized messages so as to increase the impact of the delivered materials.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention is directed to a unique system and method the use of which enables the customer or end user to order or purchase a wide range of personalized presentation folders and in quantities from a single unit to tens of units depending on the size of the audience or participants in a meeting or gathering. Such a system surprisingly is simply not available in the marketplace today and there is a compelling need for presenters of products and services or organizers of events to be able to customize his or her message in order to effectively demonstrate the products and services or convey the topics or findings to the diverse group of individuals that may be in any meeting attending any event.

In one embodiment of the present invention system and method for preparing personalized presentation folders is presented and includes the steps of initially obtaining data relating to an event, with the data including at least names of attendees for the event. Then providing at least one blank suitable for use as a presentation folder. Next, the blanks are printed with at least a portion of the data to create printed blanks. Sheets that are suitable for forming into pockets are supplied to a printing station so that the sheets can be printed with at least a portion of the data with the portion being complimentary to the data printed on the printed blanks. Next, the sheets are formed into pockets and are subsequently connected to the blanks to create a presentation folder, with the printing on the pockets cooperating with the printed blanks to form a personalized communication on each of the folders for each attendee.

In a yet still further embodiment of the present invention, a system for creating personalized presentation folders is described and includes a first data base containing information relating to an event, with the data base having at least a listing of attendees for said event. A second data base is also provided and contains information on at least one product or service being offered by a presenter of the event. The second data base may be at a location remote from the first data base or may be at the same location.

The system of the presently described embodiment further includes a computer for formatting information to be printed on a blank to be formed into a presentation folder and a sheet suitable for folding into a pocket. A communication means is also provided for communicating between the first and second data base and the computer. A printing means is connected to the computer, with the printing means capable of rendering the data or information on each blank and sheet and the printing means creates complimentary printing on each blank and the sheet when the sheet and blank are formed into a presentation folder for each attendee of the event.

In a still further embodiment of the present invention method of advertising personalized presentation folders, is described and includes the steps of initially preparing at least one personalized presentation folder, with the presentation folder having a blank and a pocket prepared independently of one another and each of the blank and pocket having indicia that is complimentary to one another. Next, marketing collateral is created that is related to the benefits of being able to present individualized presentation folders. Then the personalized presentation folders along with the marketing collateral are marketed and sold to end users.

End users of the presentation folders of the present invention include members of academia, sales and marketing professionals, personnel demonstrating products and services being offered by a particular company or entity, civil service and state and local governmental employees announcing new local and regional programs, and such other individuals and entities which would find a highly personalized communication piece useful in communicating with recipients or attendees of an event.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a flow diagram showing the steps of the present invention as they are used in the production of presentation folders;

FIG. 2 shows a schematic of the system used in the present invention to create presentation folders having personalized messages for attendees of an event;

FIG. 3 depicts a front view of the sheet of material suitable for use in the present invention and useable in creating the on demand, personalized pocket; and

FIG. 4 illustrates the use of plural pockets created by the sheet of the present invention and provides personalized information on the blank as well as on the demand pockets of the present invention; and

FIG. 5, shows the pocket of the present invention in a hinged configuration enabling the full printing of the blank and revealing other personalized information and demonstrating the blank is fully printable.

### DETAILED DESCRIPTION OF THE INVENTION

The present invention is now illustrated in greater detail by way of the following detailed description, but it should be understood that the present invention is not to be construed as being limited thereto.

As will be seen from the following detailed description, a method for preparing personalized or individualized presentation folders is presented and includes a series of steps, the progression of which will produce a highly effective marketing and or communication tool for the end user. Unexpectedly, it was found that such a system and method was not available in today's marketplace but that one is urgently needed to fill a niche that is currently not being serviced by large folder manufacturers and other producers of signatures that may be produced or provided in a book.

The printing or imaging that can be provided on the blank as well as the sheet material forming the pocket can be personalized or individualized so that each attendee of a business meeting can receive a specially tailored message. For example, a normal introductory business meeting, the attendees from the target company (company that is being targeted for the sale of goods or services) may have an executive present, members of the sales and marketing team as well as production personnel in attendance to consider the information being provided. The presenter ideally wants to deliver a unique message to each person or group in the audience and is only offered a short period of time to accomplish this task, and usually devotes most of the period to “walking through” a visual presentation. However, through the use of the present invention, the presenter can deliver personalized or individualized information to each group while still focusing on delivering the information to the group. For example, information for sales and marketing may relate to increased sales and commissions or sales strategies for selling the product. Production personnel may receive information relating to efficient manufacturing techniques and other products for which the services may be used with as well as contact numbers for support and other technical data. The executive may only receive summary or overview information and financial numbers relating to the impact of the divisional bottom line. Thus each person is provided with a unique package of information that is tailored to his or her specific talents thereby potentially increasing the chances of success of the presentation.

As used herein the term “event” refers to meetings, conferences, seminars, symposiums, gatherings, shows, groupings, sporting and theatrical performances, evaluations, reviews, academic and educational pursuits, presentations, lectures, tours, travel packages, entertainment opportunities and the like.

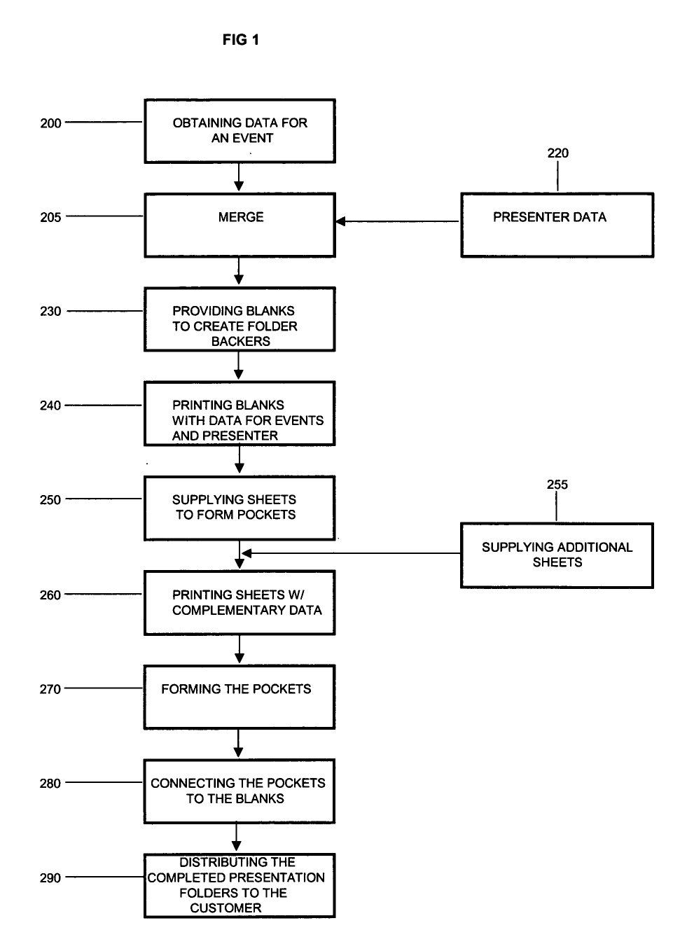

Turning now to FIG. 1 which illustrates a high level flow diagram of the steps used in the production of the highly effective marketing and communication collateral produced by the present invention. Data is collected at step designated by the reference numeral 200. The data suitable for use with the present invention includes, but is not limited to names, addresses, titles, functions, locations of attendees or other invited guests. This information or data is then combined with other data that is relevant to the presenter such as information relating to products or services, time frames for manufacturing, options that are available, contact information and related details, historical information relating to the company and its performance, credit information and letters of customer satisfaction and generally any and all information that is related to the products, services, company of the presenter for the event.

Once the data has been collected and obtained in advance of the meeting 100, the data is then merged with the data from the presenter 220 at step 250. The data of the presenter may be obtained or provided substantially simultaneously as that of the data related to the event that is being planned.

Next a series of blanks are provided at step 230. The blanks should be selected from stock that is suitable for forming the presentation folders and may include cellulosic based materials such as paper, tag or board stock to plastic films such as polyester based materials as well as metalized films and the like. If the material is not initially suited for receiving ink or toner, then the blanks or materials may be coated to anchor the toner or ink to the blank. Such coatings are generally well known in the printing and graphics arts industry.

The blanks of material are then printed or imaged at step 240. The blanks can be provided in single sheets or may be provided as part of a continuous roll fed arrangement. In the former, an exemplary sheet fed press includes the digital press INDIGO® available from Indigo, Tel Aviv, Israel or in the case of a continuous web fed press; one may opt for a XEIKON® available from Xeikon in The Netherlands. While digital presses are preferred any suitable presses or printers may be used so long as they can accommodate the size and dimension of the blanks and can provide a high quality print, including variable colors, graphics and personalized indicia.

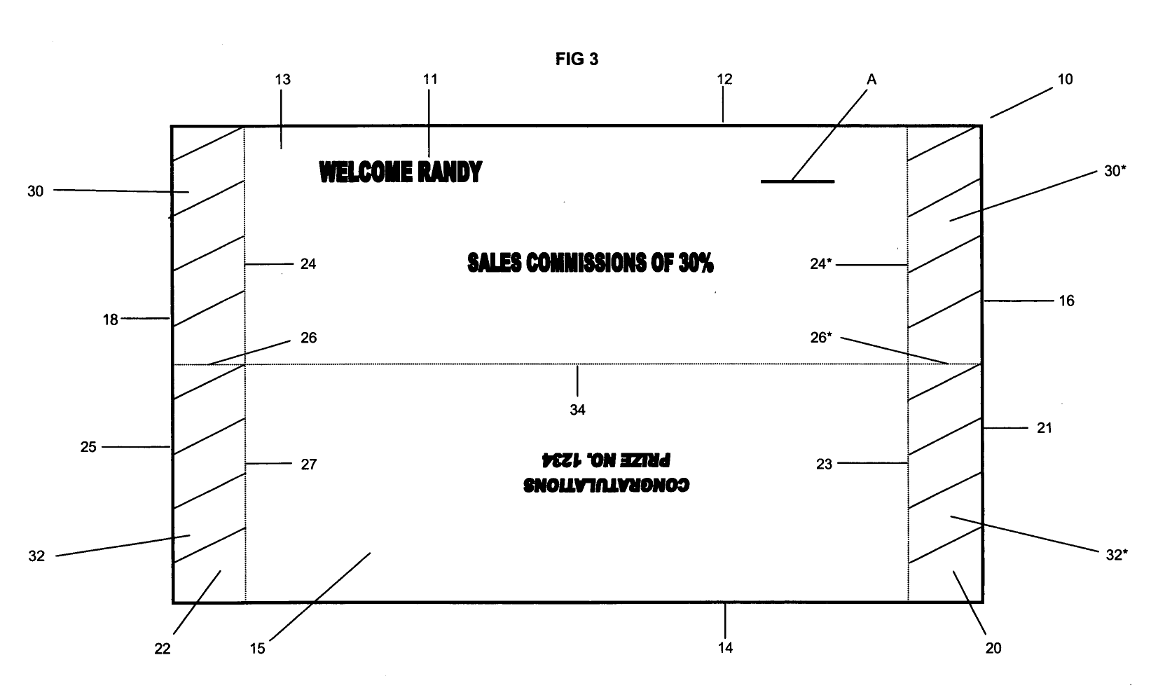

One of the unique aspects of the present invention is the ability to produce pockets on demand from individual supplies or stocks of paper or other material. This enables the manufacture to print matching or complimentary data on each pocket as it is produced and then to affix the pocket to the blank of material making up the presentation folder. An exemplary pocket suitable for use in the present invention is described in connection with the discussion around FIG. 3 provided herein.

At least one sheet is provided at step 250. The sheet needs to be suitable for accepting printing or imaging as well as to be sufficiently strong to serve as a pocket for holding the contents to be provided in a presentation folder. The sheets are printed at step 260 with imaging that is complimentary to that which is printed on the blanks and as will be evident from an inspection of the later FIGURES described herein. Additional sheets may be provided substantially simultaneously at step 255 depending on the number of pockets that are to be created in connection with a particular order or end use.

Complimentary printing as described herein includes matching information, such as repeating of names, address, locations, etc. on each of the sheets as well as the pockets. The complimentary information may also include numbers such as in creating chance games, sweepstakes and the like to heighten interest in presentation folder or presentation being given or any other indicia that is meant to compliment the products or services being offered by the presenter.

The sheets are then formed into pockets at step 270. One or more pockets may be formed from one or more sheets with the construction and arrangement of the sheets being described in connection with reference to the later described FIGURES.

Next, the pockets that are created from the sheets are then connected to the previously printed blanks at step 280 so as to form the presentation folders, or at least provide the presentation folders in an intermediate arrangement. At this stage the folders have been provided with one or more pockets depending on the needs of the customer or the event at which the presentation folders are to be provided.

Finally, the presentation folders may undergo a final step of creasing or folding and then packaging prior to being distributed to the end user or customer at step 290.

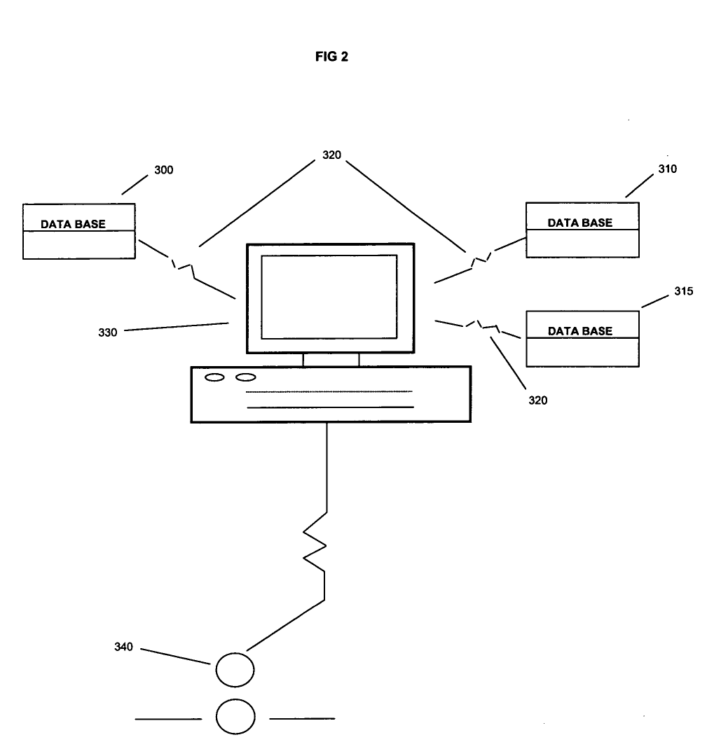

Reference is now directed to FIG. 2 in which a schematic of the present system is illustrated. A first data set is provided and designated by reference numeral 300. The first data set may contain information related to the attendees of the event, such as name, numbers, address, location, title, function and the like. A second data set is provided and designated by reference numeral 310. The second data set 310 includes information such as that provided by the presenter. The information contained in this data set may include details relating to products and services being offered by the presenter, as well as other relevant information pertinent to the presenter such as experience and knowledge within the industry, warranty information for the products, technical specifications, delivery and supply terms and such other details that would be useful in connection with presenting the information that is subject to the presentation folders.

A third data set may be provided and is designated by reference numeral 315 and may include information such as response rates to previous advertising campaigns, other advertising collateral, such as sponsors that may have supported the event, sweepstakes information and other data and materials that may be useful in promoting products and services of the presenter.

The first 300, second 310 and possibly third data set(s) 315 are connected via a communication means 320 to a central computer 330. The communication means may include a global communications network, telephone lines, local area networks (LAN) or other means suitable for conveying information from one location to another. The data sets of the present system may be provided at one location or may each be provided at distinct locations or two may be at one location and the third at a distinct location. Distinct location as used herein can refer to a single facility, having the data sets stored in different areas such as in different divisions, responsibilities or disciplines.

The data sources or set can be remote data sets or information depots instead of conventional data bases. The information may be transmitted by any suitable means such as through the use of e-mail and file attachments, zip files and the like.

The computer 330 may be any suitable device such as a personal computer (“PC”) or may be part of a larger network such as those supported by internal servers. In any event, the computer 330 is connected to a printing means 340.

The printing means 340 of the present invention may be a digital printer as described previously herein or any other suitable toner or ink jet printer that can be used in the preparation of variable indicia, delivering graphics and color to highlight the material to be presented in the presentation folders.

It should be understood that the system of the present invention may include additional data sets or data bases which can provide other information or details that would be useable in preparing the presentation folders of the present invention. Such other data bases or data sets may include a pre-established graphics data base which would enable the selection of graphics, print schemes and the like.

Turning now to FIG. 3, the sheet of material suitable for use with the present invention is provided and generally designated by reference numeral 10. The sheet 10 may be any suitable material such as paper, plastic films, metalized films or any other material that can be used to accomplish the functions of the present invention. The sheet 10 has a first face designated by “A” and a second face (not shown) which will make up the interior of the pocket once the sheet is folded. Printing 11 is provided on face A and is personalized or individualized printing intended for the recipient or user of the pocket and is to be complimentary to indicia or printing provided on the folder blank or document containment device as will later be discussed herein. It should be understood that printing can be provided on both panels 13 and 15 or only on one of the panels. When printing is provided on both panels 13 and 15, printing on one of the panels will appear upside down such that when the sheet 10 is folded, it will then appear right side up, as the panels 13 and 15 will be in a back to back configuration. Printing on the second panel may be useful when the pocket of the present invention is used in a hinged configuration or alternatively, if the blank used in creating a presentation folder has a transparent or translucent quality.

As depicted in FIG. 3, the printing on the second panel 15 has been shown to contain information relating to a prize or award so that upon moving the pocket in its hinged configuration, the attendee can see if they won a prize. Alternative embodiments include the use of the second panel 15 for additional printable area to convey a message, coupons, contact information and any other information that may be suitable for inclusion with the particular message being presented.

The sheet 10 has first and second transversely extending edges 12 and 14, and first and second longitudinally extending edges 16 and 18. The sheet is also provided with first and second strips of adhesive 20 and 22. Each of the strips of adhesive 20 and 22 have first and second side edges 21, 23 and 25 and 27 which define the area of the adhesive. As indicated previously, the adhesive may be selected from any suitable type, and in the presently described embodiment, the adhesive strips are preferably pressure sensitive tapes that are provided with a release liner that can be removed at the time of folding and/or attachment to the blank to make up the presentation folder.

The sheet 10 is also provided with first and second lines of weakness 24, 24* and 26, 26*. The second lines of weakness 26 and 26* run substantially perpendicularly to the first lines of weakness 24 and 24* and cooperate with one another to create first and second sections in the adhesive strips designated by 30, 30* and 32, 32*. The lines of weakness 24, 24* and 26, 26* may be perforations, die cuts, score lines or any other means by which to assist in the folding and removal of portions of the sheet.

The sheet 10 is also provided with a fold line 34. While FIG. 3 depicts the fold line substantially medially of the sheet, while the sheet is in a landscape position, it should be understood that the fold line 34 may appear in any portion of the sheet so as to create major and minor walls or portions (one larger than the other, that is one having more than 50% of the material). In addition, the sheet may appear in a portrait position or the fold line may run diagonally of the sheet so as to create other possible arrangements for the pocket of the present invention.

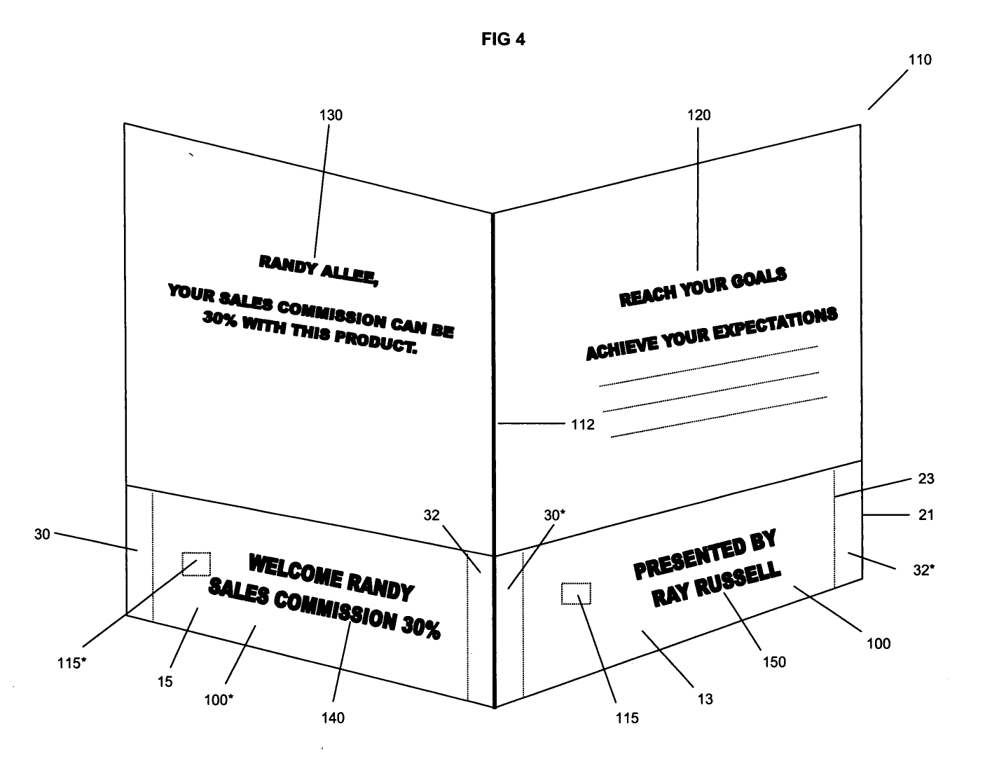

Turning now to FIG. 4, an opened presentation folder is provided and generally depicted by reference to numeral 110. In this illustration, a pair of pocket 100 and 100* have been provided and attached to the presentation folder 110. The pockets 100 and 100* have been created as previously described in reference to FIGS. 3 through 3B, but it should be understood that the pockets have different opening orientations. That is, and again referring to FIG. 3, instead of removing portions 32 and 30*, those portions remain and instead portions 30 and 32* are removed, so that pockets 100 and 100* can have a left and right sealing/opening arrangement when provided in a hinged connection.

Each of the exposed faces of the presentation folder 110 has been provided with personalized or individualized indicia as demarcated by reference numerals 120, 130, 140 and 150. The indicia may be provided by any suitable means such as ink jet, laser printers or any other printing or imaging means that can receive data and apply variably printed information.

Referring to pocket 100, the adhesive section 32*, defined by 21 and 23 has been used to seal the end edge and adhesive section 30 has been used to attach the pocket 100 to the folder 110. The adhesive section 30, initially has the adhesive exposed, such as through the removal of a liner material and is then folded back so that the adhesive is in contact with the folder 110 along the area of the spine 112, thus securing the pocket 100 to the folder 110. It should be understood that the pocket 100 may be positioned anywhere on the folder, depending on the needs of the end user. In order to hold the pocket 100 in position, a spot of adhesive 115 is used. The adhesive spot 115 may be a repositionable or removable adhesive so that the pocket can be hinged. It should be understood that the closed end of the pocket 100 or 100* may be at either end or the hinge on the other end. If one elects not to use a hinge option then a spot of permanent adhesive or transfer tape can be used to permanently secure the pocket to the folder 110. Obviously, one could still utilize a removable or repostional adhesive and just not opt to use the hinge function provided by the present invention.

An alterative arrangement would be to use the adhesive sections 30 and 32* to simply seal the ends of the pocket 100 and then apply spots of adhesive to secure the pocket to the folder 110.

FIG. 4 also shows pocket 100* secured to the folder 110 and securement of the pocket 100* to the folder 110 is achieved similarly to that provided above. Pocket 100* provides panel 15 showing, whereas pocket 100 has panel 13 facing the recipient.

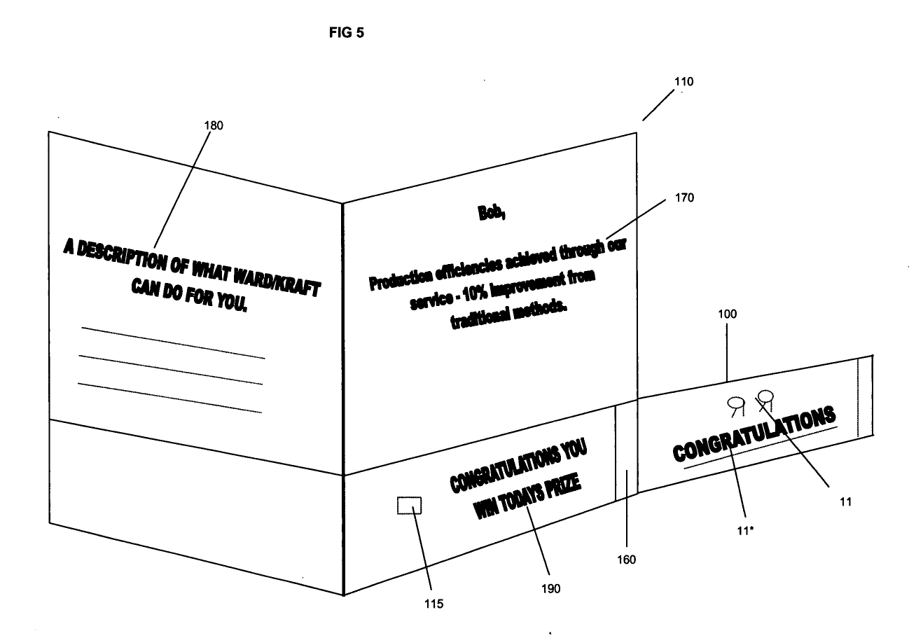

Turning now to FIG. 5 a single pocket presentation folder is provided and showing use of the pocket 100 in an opened configuration through use of hinge 160. The pocket 100 is provided with printing 11 on the front panel, shown in phantom, and printing 11* on the rear panel which reveals either part of a further message or a hidden message such as a prize award thus stimulating the recipient to look beneath the folded pocket.

The hinged pocket 100 as described earlier is connected to the folder 110 through the use of an adhesive 115, such as removable, repositional, and as already described. In this single pocket configuration, personalized indicia is also provided at 170, 180 and 190 so as to make the presentation look or appear as if it was tailored to the specific recipient.

One of the most important things with respect to new product innovations is the need to effectively market and communicate the new product to potential customers and end users of the product. Such marketing typically includes the creation of marketing collateral associated with the features of the present method and system and its benefits and uses. These unique products produced by the system and in accordance with the method of the present invention are sold in connection with that marketing collateral and then distributing the end product to potential end users and customers or transferring the technology to others for incorporation in their respective products. Customers can include distributors of such products as well as office supply stores, retail and warehouse outlets, manufacturers of such presentation folders which themselves may not be end users, but may repackage and resell the products to end users or third parties.

Marketing collateral as used herein includes the use of scripted or prepared material that are distributed through audio and visual communication mediums, over a global communication network, through printed mediums such as newspapers, trade publications, magazines, fliers, handouts and the like.

It will thus be seen according to the present invention a highly advantageous method and system for preparing personalized or individualized presentation folders has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A system and method for preparing personalized presentation folders, comprising the steps of;
obtaining data relating to an event, said data including at least names of attendees for the event;
providing at least one blank suitable for use as a presentation folder;
printing said blanks with at least a portion of said data to create printed blanks;
supplying at least one sheet suitable for forming into a pocket;
printing said at least one sheet with at least a portion of said data, said portion is complimentary to said data printed on said printed blanks;
forming said sheet into at least one pocket; and
connecting said pockets to said blanks to create a presentation folder, with said printing on said pockets cooperating with said printed blanks to form a personalized communication on each of said presentation folders for each attendee.

2. A system and method as recited in claim 1, wherein said data further includes information relating to at least one product or services being offered by a presenter for the event.

3. A system and method as recited in claim 1, including a further step of supplying a second sheet for forming into a pocket after the step of printing said first sheet.

4. A system and method as recited in claim 1, including a further step of supplying a second sheet for forming into a pocket substantially simultaneously with said step of supplying said first sheet.

5. A system and method as recited in claim 1, including a further step of providing data related to a presenter substantially simultaneously with the step of obtaining information or data related to the event.

6. A system and method as recited in claim 5, including a further step of merging the presenter data with that of the data relating to the event substantially simultaneously with the step of obtaining the data relating to the event data.

7. A system and method as recited in claim 1, including a further step of packaging the presentation folders after the step of connecting the pockets to the blanks to create the presentation folders.

8. A system and method as recited in claim 7, including the further step of distributing the presentation folders after the step of packaging.

9. A system for creating personalized presentation folders, comprising;
a first data base containing information relating to an event, said data base having at least a listing of attendees for said event;
a second data base containing information on at least one product or service being offered by a presenter of the event;
a computer for formatting information to be printed on a blank to be formed into a presentation folder and a sheet suitable for folding into a pocket;
a communication means for communicating between said first and second data base and said computer; and
a printing means connected to said computer, said printing means capable of rendering the data on each of said blank and said sheet and said printing means creating complimentary printing on each of said blank and said sheet after said sheet and said blank are formed into a presentation folder.

10. A system as recited in claim 9, wherein the first data base is at a location distinct from said second data base.

11. A system as recited in claim 9, wherein said first and second data bases are prepared separately from one another.

12. A system as recited in claim 9, wherein the printing means is a digital press.

13. A system as recited in claim 9, wherein the communication means includes a global communication network.

14. A system as recited in claim 9, wherein a third data base is provided and contains collateral information useful in presenting products and services associated with the event.

15. A system as recited in claim 14, wherein the third data base contains information related to the sponsors of a particular event.

16. A system as recited in claim 14, wherein the third data base contains information related to previous successes with advertising campaigns.

17. A method of advertising personalized presentation folders, comprising the steps of;
preparing at least one personalized presentation folder, said presentation folder having a blank and a pocket prepared independently of one another and each of said blank and pocket having indicia that is complimentary to one another;
creating marketing collateral related to benefits of being able to present individualized presentation folders; and
marketing said personalized presentation folders along with said marketing collateral to end users.

18. A method of advertising personalized presentation folders as provided in claim 17, wherein said marketing collateral includes scripted or prepared material that are distributed through audio and visual communication mediums, over a global communication network, through printed mediums such as newspapers, trade publications, magazines, fliers, handouts and combinations thereof.
